(19) United States
(12) Patent Application Publication
(10) Pub. No.: US 2018/0166829 A1
(43) Pub. Date: Jun. 14, 2018

(54) PLUG CONNECTOR AND RECEPTACLE CONNECTOR USING CERAMIC, AND MANUFACTURING METHOD THEREFOR

(71) Applicant: SRB CO., LTD., Seongnam-si, Gyeonggi-do (KR)

(72) Inventors: Jae Hyuk CHOI, Seoul (KR); Hoon AHN, Anyang-si (KR); Seong Kyu LIM, Seoul (KR); Woo Jeong KANG, Yongin-si (KR)

(73) Assignee: SRB CO., LTD., Seongnam-si, Gyeonggi-do (KR)

(21) Appl. No.: 15/579,565

(22) PCT Filed: Jun. 8, 2016
(86) PCT No.: PCT/KR2016/006046

§ 371 Date: Dec. 4, 2017

(30) Foreign Application Priority Data
Jun. 12, 2015 (KR) 10-2015-0083619

(51) Int. Cl. H01R 13/6581; H01R 13/6598; H01R 24/62; H01R 24/50; H01R 12/71

(52) U.S. Cl. CPC H01R 13/6581; H01R 13/6598; H01R 12/71; H01R 24/50; H01R 24/62

(57) ABSTRACT

Disclosed are a plug connector and a receptacle connector that have improved structures, and methods of manufacturing the same. A plug connector according to an embodiment of the present invention includes an upper ceramic substrate, a lower ceramic substrate, upper plug contacts, lower plug contacts, a pair of metal members, and a ceramic plug shell. The upper ceramic substrate is provided with a terminal at a lower surface thereof. The lower ceramic substrate is configured to correspond to the upper ceramic substrate and is provided with a terminal at an upper surface thereof. The upper plug contacts are coupled to the terminal of the upper ceramic substrate and each include a downwardly protruding contact portion. The lower plug contacts are coupled to the terminal of the lower ceramic substrate and each include an upwardly protruding contact portion. The pair of metal members include through-holes, respectively, formed at portions thereof corresponding to the upper plug contacts and the lower plug contacts, respectively and are coupled to an upper portion of the upper ceramic substrate and a lower portion of the lower ceramic substrate, respectively. The ceramic plug shell has a hollow cylindrical shape and is coupled in a form covering the metal members.

### TECHNICAL FIELD

The present invention relates to a plug connector and a receptacle connector, and more particularly, to a receptacle connector mounted on a printed circuit board in an electronic device and a plug connector fastened to the receptacle connector to correspond thereto.

### BACKGROUND ART

Connector devices are used to electrically connect circuit boards to each other or a circuit board with an electronic component using an FPCB or the like.

Recently, connector devices have been widely applied to circuit boards such as those in portable terminals, etc., and are required to become more lightweight, thinner, shorter, and smaller as electronic devices tend to be miniaturized. In addition, as the density of electronic elements mounted on a circuit board increases, the number of contacts installed in a connector device also increases and an arrangement pitch between the contacts is also increasingly narrower.

Generally, a connector device consists of a receptacle in which a plurality of receptacle contacts is installed in a receptacle insulator, and a plug in which a plurality of plug contacts, contacting the receptacle contacts in a one-to-one manner, is installed in a plug insulator.

The receptacle contacts and the plug contacts are connected to a receptacle-side cable and a plug-side cable, respectively, or are mounted on a circuit board. When a plug is inserted into a receptacle so that the receptacle contacts are brought into contact with the plug contacts, the receptacle-side cable and the plug-side cable or circuits of the circuit boards are electrically connected to each other. Thus, the connector performs data communication with an external device or power is supplied thereto.

As an example of a conventional plug connector, a micro USB plug connector is illustrated in FIGS. 1 and 2. In the micro USB plug connector illustrated in FIGS. 1 and 2, five plug contacts 30 are positioned between insulators 10 made of a plastic material and thus are insulated by the insulators 10. In addition, a shell 20 made of a metal material covers and protects the insulators 10.

However, the shell of such a conventional plug connector and a shell of a receptacle connector are made of a metal material, and thus the plug connector and the receptacle connector are damaged due to physical contact therebetween in a process of repeatedly inserting the plug connector into the receptacle connector. In addition, the plug connector and the receptacle connector have complicated structures, and thus manufacturing costs thereof are high.

### DISCLOSURE

### Technical Problem

Therefore, the present invention has been made in view of the above problems, and it is one object of the present invention to provide a plug connector and a receptacle connector that have improved structures.

It is another object of the present invention to provide methods of fabricating a plug connector and a receptacle connector by simple manufacturing processes and at low manufacturing costs.

### Technical Solution

A plug connector according to an embodiment of the present invention includes an upper ceramic substrate, a lower ceramic substrate, an upper plug contact, a lower plug contact, a pair of metal members, and a ceramic plug shell. The upper ceramic substrate is provided with a terminal at a lower surface thereof. The lower ceramic substrate is configured to correspond to the upper ceramic substrate and is provided with a terminal at an upper surface thereof. The upper plug contact is coupled to the terminal of the upper ceramic substrate and has a downwardly protruding contact portion. The lower plug contact is coupled to the terminal of the lower ceramic substrate and has an upwardly protruding contact portion. The pair of metal members include through-holes, respectively, formed at portions thereof corresponding to the upper plug contact and the lower plug contact, respectively and are coupled to an upper portion of the upper ceramic substrate and a lower portion of the lower ceramic substrate, respectively. The ceramic plug shell has a hollow cylindrical shape and is coupled in a form covering the metal members.

In another embodiment of the present invention, one of the metal members is provided, at a surface thereof, with a coupling projection to maintain a fastened state between the metal member and a substrate of a corresponding receptacle connector when inserted into the corresponding receptacle connector.

According to another embodiment of the present invention, a method of manufacturing a plug connector using ceramic may include arranging upper and lower ceramic substrates each provided with a terminal; fusing upper and lower plug contacts to the terminal of the upper ceramic substrate and the terminal of the lower ceramic substrate, respectively; press-molding a pair of metal members such that through-holes are formed in portions thereof corresponding to the upper plug contact and the lower plug contact, respectively, and a coupling projection is formed in one of the pair of metal members to maintain a fastened state between the metal member and a substrate of a corresponding receptacle connector when inserted into the corresponding receptacle connector; assembling the pair of metal members and the upper and lower ceramic substrates; fabricating a plug shell having a hollow cylindrical shape using ceramic; and coupling an assembled structure of the pair of metal members and the upper and lower ceramic substrates to the plug shell. According to another embodiment of the present invention, a receptacle connector using ceramic may include a ceramic substrate provided with a terminal at a surface thereof; a housing having a hollow cylindrical shape with fastening grooves to maintain a fastened state when a corresponding plug connector is inserted into the housing, coupled to the ceramic substrate in a form covering the ceramic substrate, and made of a metal material; and a ceramic receptacle shell having a hollow cylindrical shape and coupled to the housing in a form covering the housing.

According to another embodiment of the present invention, a method of manufacturing a receptacle connector using ceramic may include arranging a ceramic substrate having a terminal, press-molding a metal plate into a hollow cylindrical shape and coupling the ceramic substrate to an inside thereof, fabricating a receptacle shell having a hollow cylindrical shape using ceramic, and coupling the receptacle shell to an outer surface of the metal member with the ceramic substrate coupled thereto.

### Advantageous Effects

According to the present invention, a plug shell that forms an external appearance of a plug connector and a receptacle shell that forms an external appearance of a receptacle connector are made of ceramic, and thus the plug connector and the receptacle connector can have various colors.

In addition, coupling between the plug connector and the receptacle connector is facilitated due to flexibility of the ceramic.

In addition, the plug connector and the receptacle connector, according to the present invention, do not have problems such as breakdown, and the like even after long-term use.

### DESCRIPTION OF DRAWINGS

FIG. 1 is a perspective view for explaining a use state of a plug connector.

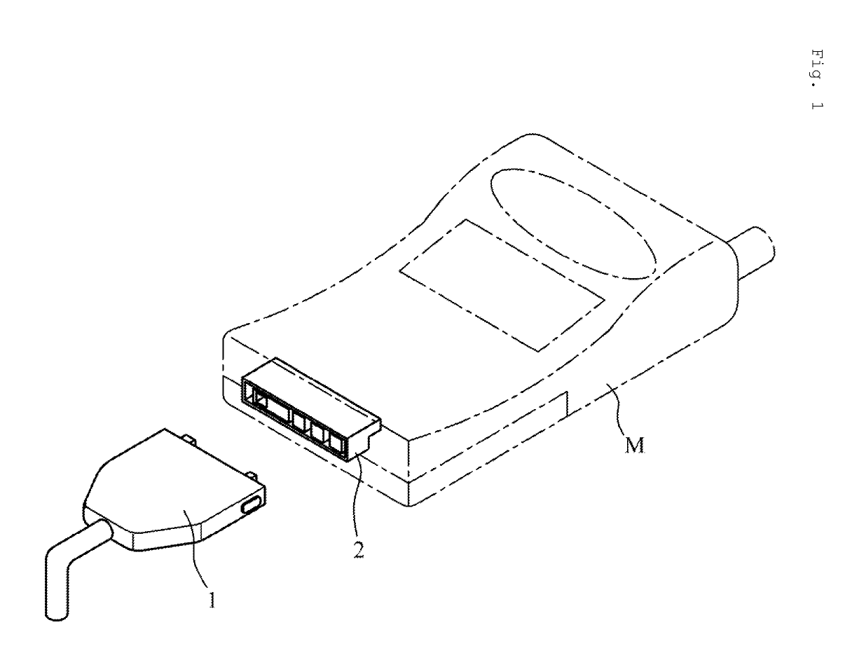

FIG. 2 is a perspective view illustrating a structure of a conventional plug connector.

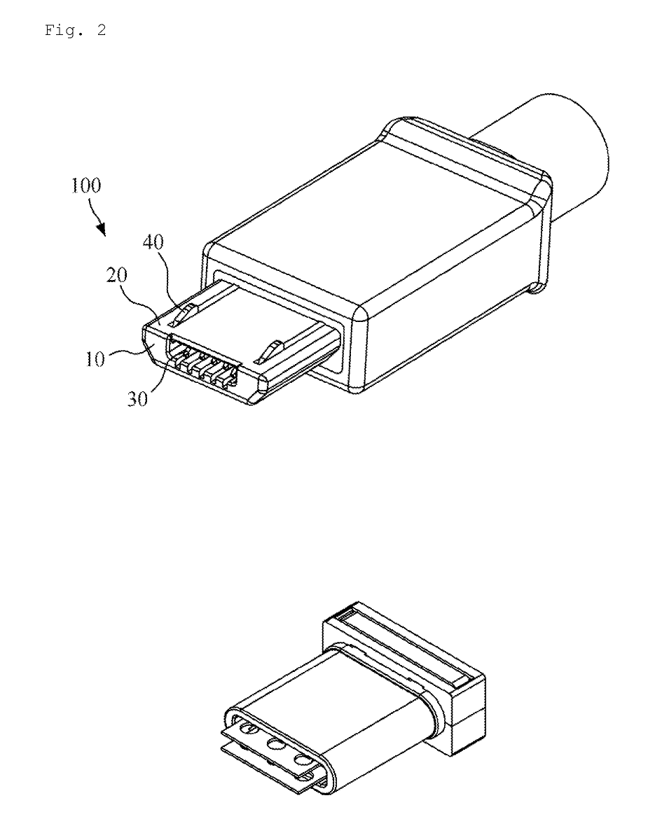

FIG. 3 is a perspective view of a plug connector according to an embodiment of the present invention.

FIG. 4 is a perspective view of a receptacle connector according to an embodiment of the present invention.

### BEST MODE

The above and other aspects will become apparent from embodiments described below. In the present specification, like reference numerals denote like elements in the drawings. In addition, the shapes or sizes of elements may be exaggerated. In addition, detailed explanations of related art are omitted when it is deemed that they may unnecessarily obscure the essence of the invention.

Hereinafter, the present invention will be described in detail with reference to the accompanying drawings.

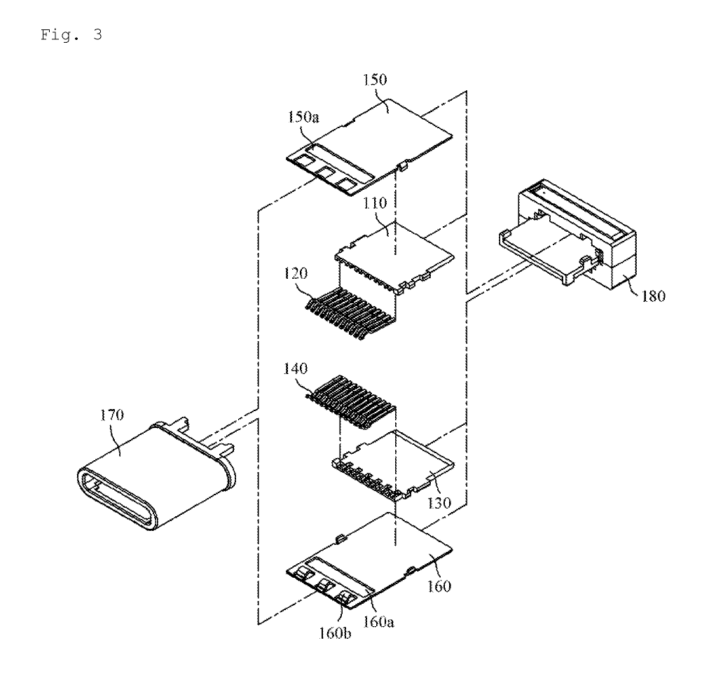

FIG. 3 is a perspective view of a plug connector according to an embodiment of the present invention.

Referring to FIG. 3, the plug connector includes an upper ceramic substrate 110, a lower ceramic substrate 130, upper plug contacts 120, lower plug contacts 140, a pair of metal members 150 and 160, and a ceramic plug shell 170. The upper ceramic substrate 110 is provided with a terminal (not shown) at a lower surface thereof. The ceramic substrate may be made using low temperature co-fired ceramic (LTCC) calcined at 1,000° C. or less or high temperature co-fired ceramic (HTCC) calcined at 1,500° C. or more. The ceramic substrate may have various shapes such as a tetragonal shape, and the like. The terminal is arranged using a deposition technique, or by printing, and may be electroplated to reinforce the function thereof.

The lower ceramic substrate 130 is configured to correspond to the upper ceramic substrate 110 and is provided with a terminal (not shown) at an upper surface thereof. Similar to the upper ceramic substrate 110, the lower ceramic substrate 130 may also be made of LTCC or HTCC. In addition, the lower ceramic substrate 130 may have the same external appearance as that of the upper ceramic substrate 110.

The upper plug contacts 120 are coupled to the terminal of the upper ceramic substrate 110 and each includes a downwardly protruding contact portion. The number of the upper plug contacts 120 may be ½ of the total number of pins of the plug connector. The contact portions may have a semi-circular form. The contacts portions of the respective upper plug contacts 120 are brought into contact with a terminal arranged at an upper surface of a substrate of a receptacle connector, and thus may transmit an electrical signal. The upper plug contacts 120 may be fabricated by press molding. The upper plug contacts 120 may be coupled to the terminal of the upper ceramic substrate 100 using brazing welding.

The lower plug contacts 140 are coupled to the terminal of the lower ceramic substrate 130 and each includes an upwardly protruding contact portion. The number of the lower plug contacts 140 may be ½ of a total number of pins of the plug connector. The contact portions may have a semi-circular form. The contact portions of the respective lower plug contacts 140 are brought into contact with a terminal arranged at a lower surface of the substrate of the receptacle connector, and thus may transmit an electrical signal. The lower plug contacts 140 may be fabricated by press molding. The lower plug contacts 140 may be coupled to the terminal of the upper ceramic substrate 130 using brazing welding. The pair of metal members 150 and 160 include through-holes 150a and 160a, respectively, formed at portions thereof corresponding to the upper plug contacts 120 and the lower plug contacts 140, respectively, and are coupled to an upper portion of the upper ceramic substrate 110 and a lower portion of the lower ceramic substrate 130, respectively. The pair of metal members 150 and 160 may be fabricated by press molding. The through-holes 150a and 160a may have a rectangular shape. The through-holes 150a and 160a may be provided with a plurality of protrusions to hold the positions of the respective upper and lower plug contacts 120 and 140 and to prevent contact between the corresponding plug contacts. The pair of metal members 150 and 160 serve to shield EMI.

The ceramic plug shell 170 has a hollow cylindrical shape and is coupled in a form covering the metal members 150 and 160. The ceramic plug shell 170 may have an oval cross-section. The ceramic plug shell 170 may be colored using a pigment. When the ceramic plug shell 170 that forms an external appearance of the plug connector is colored, aesthetics may be enhanced.

In the plug connector made of ceramic as described above, the plug shell that forms an external appearance thereof is made of ceramic, and thus may have various colors. In addition, coupling between the plug connector and the receptacle connector is facilitated due to flexibility of the ceramic. In addition, substrates are made of a ceramic with excellent heat dissipation and highly resistant to high temperature, and thus the plug connector does not break down even after long-term use.

In addition, as illustrated in FIG. 3, the metal member 160 may be provided, at a surface thereof, with coupling projections 160b that maintain a fastened state when inserted into the corresponding receptacle connector. The coupling projections 160b may be formed into a semi-circular shape to protrude from a surface of any one of the pair of metal members, i.e., the metal member 160, and holes corresponding thereto may be formed in the other metal member 150. In a case in which the coupling projections 160b are formed, the fastened state when the plug connector is inserted into the corresponding receptacle connector may be stably maintained even when external impact is applied.

In addition, the plug connector may further include a housing 180 that maintains coupling between the pair of metal members 150 and 160 and the ceramic plug shell 170 and may be used as a handle when in use. A method of manufacturing a plug connector using ceramic will now be described with reference to FIG. 3.

First, the upper and lower ceramic substrates 110 and 130 each provided with a terminal are arranged. The ceramic substrates may be made of LTCC or HTCC. The terminal may be formed by depositing or printing a conductor on ceramic. Next, the upper plug contacts 120 and the lower plug contacts 140 are fused to the terminal of the upper ceramic substrate 110 and the terminal of the lower ceramic substrate 130, respectively. The upper and lower plug contacts 120 and 140 may be fused to the terminals of the upper and lower ceramic substrates 110 and 130 by brazing.

Next, the metal members 150 and 160 are press-molded such that the through-holes 150a and 160a are formed in portions thereof corresponding to the upper plug contacts 120 and the lower plug contacts 140, respectively, and the coupling projections 160b are formed in the metal member 160 to maintain the fastened state when inserted into the corresponding receptacle connector. The through-holes 150a and 160a may have a rectangular form. The through-holes 150a and 160a may be provided with a plurality of protrusions to hold the respective upper and lower plug contacts 120 and 140 in place and prevent contact between the upper and lower plug contacts 120 and 140.

Next, the pair of metal members 150 and 160 and the upper and lower ceramic substrates 110 and 130 are assembled. To facilitate assembly thereof, guide projections (not shown) may be formed at the pair of metal members 150 and 160.

Next, the plug shell 170 having a hollow cylindrical shape is fabricated using ceramic. The ceramic plug shell 170 may have an oval cross-section. The ceramic plug shell 170 may be colored using a pigment.

Next, the assembled structure of the pair of metal members 150 and 160 and the upper and lower ceramic substrates 110 and 130 is coupled to the plug shell 170. The assembled structure of the pair of metal members 150 and 160 and the upper and lower ceramic substrates 110 and 130 may be inserted into a hollow portion of the ceramic plug shell 170 to be coupled thereto.

In the above-described method of manufacturing a plug connector using ceramic, insertion molding is not used to fabricate the plug contacts 120 and 140, and thus manufacturing processes are simple. Thus, when the method according to the present invention is used, productivity may be enhanced.

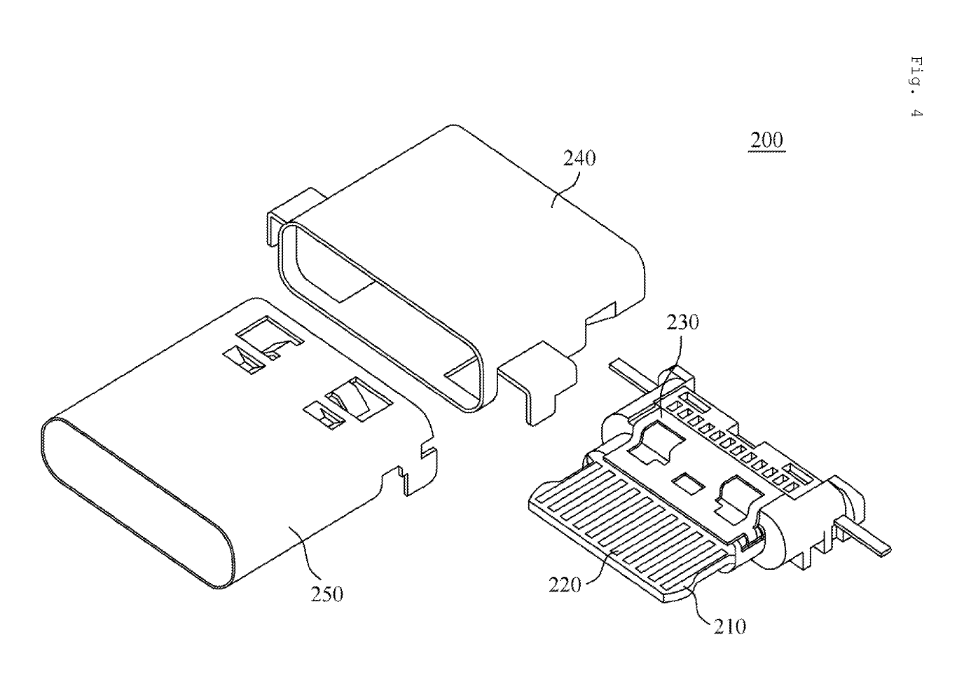

FIG. 4 is a perspective view of a receptacle connector 200 according to an embodiment of the present invention.

Referring to FIG. 4, the receptacle connector 200 includes a ceramic substrate 210, a housing 250, and a ceramic receptacle shell 240.

The ceramic substrate 210 are provided with terminals 220 at a surface thereof. The ceramic substrate 210 may be made of LTCC or HTCC. The terminals 220 may be formed by depositing or printing a conductor on ceramic.

The housing 250 made of a metal material, has a hollow cylindrical shape with fastening grooves that maintain the fastened state when the corresponding plug connector is inserted into the housing 250, and is coupled to the ceramic substrate 210 in a form covering the ceramic substrate 210. The housing 250 made of a metal material serves to shield EMI.

The ceramic receptacle shell 240 has a hollow cylindrical shape and is coupled to the housing 250 in a form covering the housing 250. The ceramic receptacle shell 240 may have an oval cross-section. The ceramic receptacle shell 240 may be colored using a pigment. When the ceramic receptacle shell 240 that forms an external appearance of the receptacle connector 200 is colored, aesthetics thereof may be enhanced.

A receptacle connector using ceramic configured as described above may have various colors because a receptacle shell that forms an external appearance thereof is made of ceramic. In addition, the receptacle connector is fabricated using a ceramic substrate, and thus does not break down even after long-term use.

In addition, the receptacle connector 200 using ceramic may further include a connection member 230 that connects the housing 250 made of a metal material to the ceramic substrate 210.

A method of manufacturing a receptacle connector using ceramic will now be described with reference to FIG. 4.

First, a ceramic substrate provided with terminals is arranged. The ceramic substrate may be fabricated using LTCC or HTCC. The terminals may be formed by depositing or printing a conductor on ceramic.

Next, a metal plate is press-molded into make a hollow cylindrical form and the ceramic substrate is coupled to an inside of the hollow cylindrical form. In this case, the metal plate may include fastening grooves to maintain the fastened state when the corresponding plug connector is inserted thereinto.

Next, a receptacle shell having a hollow cylindrical shape is fabricated using ceramic. The receptacle shell may have an oval cross-section. The receptacle shell may be colored using a pigment.

Next, the receptacle shell is coupled to an outer surface of a metal member to which the ceramic substrate is coupled.

The above-described method of manufacturing a receptacle connector using ceramic has simple manufacturing processes and high productivity.

While embodiments of the present invention have been described with reference to the accompanying drawings, these are provided for illustrative purposes only. In addition, it will be understood by one of ordinary skill in the art that various changes and other equivalent embodiments can be made. Thus, the true spirt and scope of the present invention should be defined only by the following claims.

1. A plug connector using ceramic, comprising:
an upper ceramic substrate provided with a terminal at a lower surface thereof;
a lower ceramic substrate configured to correspond to the upper ceramic substrate and provided with a terminal at an upper surface thereof;
an upper plug contact coupled to the terminal of the upper ceramic substrate and having a downwardly protruding contact portion;
a lower plug contact coupled to the terminal of the lower ceramic substrate and having an upwardly protruding contact portion;
a pair of metal members comprising through-holes, respectively, formed at portions thereof corresponding to the upper plug contact and the lower plug contact, respectively and coupled to an upper portion of the upper ceramic substrate and a lower portion of the lower ceramic substrate, respectively; and
a ceramic plug shell having a hollow cylindrical shape and coupled in a form covering the metal members.

2. The plug connector according to claim 1, wherein one of the metal members is provided, at a surface thereof, with a coupling projection to maintain a fastened state between the metal member and a substrate of a corresponding receptacle connector when one of the metal members inserted into the corresponding receptacle connector.

3. A method of manufacturing a plug connector using ceramic, the method comprising:
arranging upper and lower ceramic substrates each provided with a terminal;
fusing upper and lower plug contacts to the terminal of the upper ceramic substrate and the terminal of the lower ceramic substrate, respectively;
press-molding a pair of metal members such that through-holes are formed in portions thereof corresponding to the upper plug contact and the lower plug contact, respectively, and a coupling projection is formed in one of the pair of metal members to maintain a fastened state between the metal member and a substrate of a corresponding receptacle connector when one of the pair of the metal members inserted into the corresponding receptacle connector;
assembling the pair of metal members and the upper and lower ceramic substrates;
fabricating a plug shell having a hollow cylindrical shape using ceramic; and
coupling an assembled structure of the pair of metal members and the upper and lower ceramic substrates to the plug shell.

4. A receptacle connector using ceramic, comprising:
a ceramic substrate provided with a terminal at a surface thereof;
a housing having a hollow cylindrical shape with fastening grooves to maintain a fastened state when a corresponding plug connector is inserted into the housing, coupled to the ceramic substrate in a form covering the ceramic substrate, and made of a metal material; and
a ceramic receptacle shell having a hollow cylindrical shape and coupled to the housing in a form covering the housing.
